(19) United States
(12) Patent Application Publication
(10) Pub. No.: US 2021/0241366 A1
(43) Pub. Date: Aug. 5, 2021

(54) SYSTEM AND METHOD FOR PROVIDING AND RECEIVING GOODS AND SERVICES

(71) Applicants: Mohamed Abdulla Aldhaheri, Rochester, MN (US); Khalifa Abdulla Aldhaheri, Rochester, MN (US); Hadef Saqer Aldhaheri, Abu Dhabi Island (AE); Mohammed Saqer Aldhaheri, Abu Dhabi Island (AE)

(72) Inventors: Mohamed Abdulla Aldhaheri, Rochester, MN (US); Khalifa Abdulla Aldhaheri, Rochester, MN (US); Hadef Saqer Aldhaheri, Abu Dhabi Island (AE); Mohammed Saqer Aldhaheri, Abu Dhabi Island (AE)

(21) Appl. No.: 17/156,311

(22) Filed: Jan. 22, 2021

Related U.S. Application Data
(60) Provisional application No. 62/968,790, filed on Jan. 31, 2020.

(51) Int. Cl. G06Q 30/08; G06Q 30/06

(52) U.S. Cl. CPC G06Q 30/08; G06Q 30/0625; G06Q 30/0641

(57) ABSTRACT

A system and method for providing goods and services includes at least one user interface device for operation by a customer, at least one user interface device for operation by a personalized services provider, at least one seller interface device, and a platform provider environment comprising at least one computer system, for providing an online marketplace. The platform functions to establish communication between the various interfaces to facilitate a purchase of one or more items between a seller and a customer, and one or more personalized services between the customer and a services provider. The purchase between the customer and seller includes an ownership transfer of a physical good, and the purchase between the customer and services provider involves the services provider conducting a physical transformation or conveyance of the purchased good.

### CROSS-REFERENCE TO RELATED APPLICATIONS

This application claims the benefit of U.S. application Ser. No. 62/968,790 filed on Jan. 31, 2020, the contents of which are incorporated herein by reference.

### TECHNICAL FIELD

The present invention relates generally to the retail and services industry, and more particularly to a system and method for blending user-provided services with retail services.

### BACKGROUND

The statements in this section merely provide background information related to the present disclosure and may not constitute prior art.

There are many existing marketplace websites where goods and services can be purchased by consumers. Each of these platforms are designed to function in a single direction wherein the goods/services are provided by one group (e.g., Sellers) and offered to another group (e.g., Consumers) in exchange for payment. Although these sites are useful, they do not afford users the opportunity to offer their own services which may be beneficial to other site users. More specifically, such platforms do not allow users to provide personalized services that are related to the goods purchased from sellers on the platform, such as offering pickup, delivery, modifications and the like, while also being able to participate in the platform as a consumer.

The present invention directed to a system and method for providing and receiving goods and services differs from the conventional art in a number of aspects. The manner by which will become more apparent in the description which follows, particularly when read in conjunction with the accompanying drawings.

### SUMMARY OF THE INVENTION

The present invention is directed to a system and method for providing goods and services whereby services include personalized service offerings by system users.

One embodiment of the system can include at least one user interface device for operation by a customer, at least one user interface device for operation by a personalized services provider, at least one seller interface device, and a platform provider environment comprising at least one computer system, for providing an online marketplace.

The platform can function to establish communication between the various interfaces to facilitate a purchase of one or more items between a seller and a customer, and one or more personalized services between the customer and a services provider.

The purchase between the customer and seller can include an ownership transfer of a physical good, and the purchase between the customer and services provider can involve the services provider conducting a physical transformation or conveyance of the purchased good.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a schematic illustration of an exemplary system for providing and receiving goods and services that is useful for understanding the inventive concepts disclosed herein.

FIG. 2 shows an exemplary flow diagram illustrating a method of providing and receiving goods and services using the platform.

FIG. 3A shows an exemplary user interface of the platform, in accordance with one embodiment of the invention.

FIG. 3B shows an exemplary user interface of the platform, in accordance with one embodiment of the invention.

FIG. 3C shows an exemplary user interface of the platform, in accordance with one embodiment of the invention.

FIG. 4A shows an exemplary user interface of the platform, in accordance with one embodiment of the invention.

FIG. 4B shows an exemplary user interface of the platform, in accordance with one embodiment of the invention.

FIG. 4C shows an exemplary user interface of the platform, in accordance with one embodiment of the invention.

FIG. 4D shows an exemplary user interface of the platform, in accordance with one embodiment of the invention.

FIG. 4E shows an exemplary user interface of the platform, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Identical reference numerals are used for like elements of the invention or elements of like function. For the sake of clarity, only those reference numerals are shown in the individual figures which are necessary for the description of the respective figure.

Although described throughout this document with regard to individual platform users offering services to other platform users, this is but one possible implementation of the system. Accordingly, the system and methodology described herein can be applied toward businesses offering services to consumers and other businesses, including those located at distant geographic locations, so as to allow users to enjoy the platform functionality for myriad of services at any location across the globe.

### Definitions

As described herein, the term “user” can describe any person, group or legal entity who utilizes one or more aspects of the platform as either a seller, consumer, or service provider.

As described herein, the term “consumer” can describe a user who utilizes one or more aspects of the system and method to receive goods or services.

As described herein, the term “Seller” can describe a user who offers goods or commercial services for sale utilizing one or more aspects of the system and method.

As described herein, the term “commercial services” can include any number of general services that are offered by sellers and/or their affiliates to consumers using the system. Several nonlimiting examples of commercial services that can be offered by sellers include, but are not limited to: appliance repair, automotive repair, home A/C services, plumbing services, electrician services, maid services, painting services, dry cleaning services, and lawn care, for example.

As described herein, the terms “service provider” and “provider” can be used interchangeably to describe a user who offers personal services to consumers utilizing one or more aspects of the system and method. Depending on the actions being taken, it is noted that a service provider may also be a consumer and vice versa.

As described herein, the term “Personal Services” can include specified services that are unique to or focused on goods or commercial services purchased by a consumer from a seller using the system. Several nonlimiting examples of personalized services that can be offered by providers include but are not limited to: pickup and delivery of purchased goods from a seller location to a consumer location, pickup and delivery of consumer-owned items to a seller location to receive a purchased commercial service (e.g., deliver clothing to dry cleaner), among many others, for example.

As described above, each Consumer, Seller and Provider may be physically located in any geographic location anywhere in the world, and can work with other system users to provide, or purchase goods and services. As such, the system is not to be construed as limiting to any particular area, as both services and goods can be purchased and sold by consumers, sellers and providers located in different areas of the world.

As described herein, the terms “platform provider” and “system management” are used interchangeably, and can include an individual, group or legal entity that is overseeing, providing and/or performing various aspects of the below described system and method steps which makes the Platform available.

In one embodiment, the disclosed system and method can be performed in part, by a plurality of computer systems utilizing one or more websites to interface with users. To this end, each of the one or more websites may utilize any number of different names and/or URL addresses. Additionally, it is contemplated that several different methods can be performed via the platform simultaneously using different websites that are directed towards different individual markets and/or geographic locales, for example. Such methods can be performed under the direct supervision of the original platform provider, or via secondary providers through a franchise, license, or other form of legal agreement.

The below described system and method can provide a platform that functions to allow consumers to purchase goods and services from sellers in the traditional business-to-customer (B2C) model, whereby sellers can sell and ship goods directly to buyers, along with performing a wide range of services. Additionally, the platform provides a mechanism for operating in a customer-to-customer (C2C) model allowing system users (e.g., providers) to offer personalized services to other system users (e.g., consumers) that are related to sales from a seller.

As will be appreciated by one skilled in the art, aspects of the present invention may be embodied as a system, method, and/or computer program product. Therefore, aspects of the present invention may take the form of an entirely hardware embodiment, or an embodiment combining software and hardware aspects that may all generally be referred to herein as a “unit”, “module,” “system”, or “feature.” Furthermore, aspects of the present invention may take the form of a computer program product embodied in one or more computer readable medium(s) having computer readable program code embodied thereon, while other aspects may utilize traditional mechanisms for conducting voice communications.

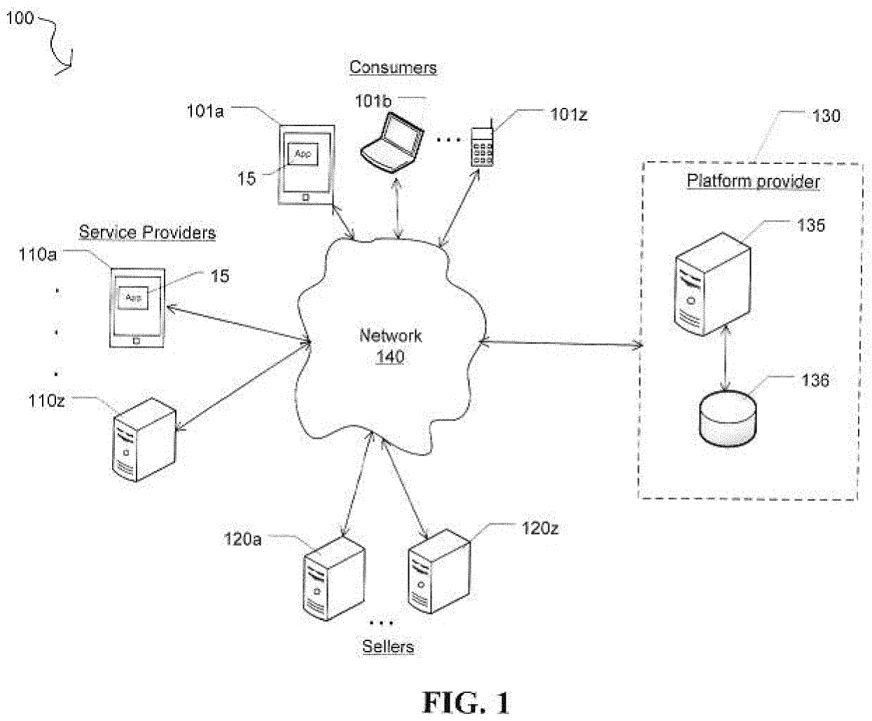

FIG. 1 is a schematic illustration of an exemplary system for providing and receiving goods and services, in accordance with one embodiment. The system 100 can include, for example, a plurality of consumers each utilizing an interface device 101a-101z, a plurality of providers each utilizing an interface device 110a-110z, and a plurality of sellers each utilizing an interface device 120a-120z, that are communicating with each other and a platform provider system 130 over a network 140.

As described herein, an interface device can include any type of processor-enabled device such as a computer, tablet, PDA, smart phone, smart watch, and other such components, for example, that can be operated by a human user.

To this end, consumers can utilize an interface device 101a-101z to browse, research, and purchase any type of goods and services offered by sellers and providers through the system. Likewise, providers can utilize an interface device 110a-110z to offer customized services to consumers that are related to a purchase from a seller. Depending on the actions being taken, it is noted that a provider may also be a consumer and vice versa. Additionally, sellers can utilize an interface device 120a-120z to list and sell any type of goods and services to consumers through the system.

The platform provider system 130, according to one embodiment, can include one or more individual computing devices 135 that can be connected to one or more databases 136 on which various portions of the method can be performed.

One example of a database 136 for use herein can include one or more independent storage devices that can function to receive and store information for the performance of the method steps, and/or information such as product and services listings, pricing, communication protocols, tracking of orders and payment information. Several nonlimiting examples include various types of computer-readable storage mediums, such as semiconductor memory devices, e.g., DRAM, SRAM, EPROM, EEPROM, and flash memory devices, magnetic disks, e.g., internal hard disks or removable disks, for example.

The platform provider system 130 can also function to provide a central hub for controlling the communication between the above-described interface devices through any number of different mediums such as the above noted website, for example, along with any number of secure and/or encrypted messaging and communication protocols. In this regard, one or more of the individual computing devices 135 of the platform provider system can comprise a web server, an email server, a communication server, and so forth, or the system can employ one or more single server-type devices which function to handle each of these processes.

The platform system 130 can also include functionality for providing one or more mobile applications 15 that can be downloaded onto an interface device. In this regard, the system can provide or generate any number of different display screens on each of the interface devices in order to provide consumers, providers and sellers with the ability to view, research, offer, buy, bid or sell goods and services. To this end, portions of the methodology can be implemented as a computer program product, which can be written in any form of computer or programming language for use with any form of processor enabled device.

Owing to the nature of the information to be shared across the system components, one or more of the platform system servers 135, can be constructed as a purpose-built device having dedicated and password protected internal or external storage mediums. These purpose-built devices can further include secure network interfaces to ensure that the purpose-built non-generic processor enabled devices perform the below described methodology in a completely secure manner that cannot be achieved through the use of off-the-shelf hardware. Such a feature being beneficial to ensure the secure transfer of information between various parties utilizing the system.

As described herein, the network 140 can include any type of transmission medium that facilitates any form of digital or analog communication (e.g., a communication network). Transmission mediums can include one or more packet-based networks and/or one or more circuit-based networks in any configuration. Packet-based networks can include, for example, the Internet, a carrier internet protocol (IP) network (e.g., local area network (LAN), and/or a wide area network (WAN). Circuit-based networks can include, for example, the public switched telephone network (PSTN), a wireless network (e.g., RAN, code-division multiple access (CDMA) network, time division multiple access (TDMA) network, global system for mobile communications (GSM) network), Bluetooth, WiFi, or Personal Area Networks (PANs), Near Frequency Communication (NFC) network, and/or other circuit-based networks.

Information transfer over the network 140 can be performed by a communication module based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), a Global System for Mobile Communications (GSM) protocol, a Push-to-Talk (PTT) protocol, a PTT over Cellular (POC) protocol, a Real-time Messaging protocol (RTMP), a Real-time Media Flow Protocol (RTMFP) and/or other communication protocols.

Various methods for providing and receiving goods and services utilizing the above noted system platform will now be described. The methods are exemplary in nature to demonstrate the ability of a system user to purchase goods and services from sellers in the traditional B2 C model, whereby sellers can sell and ship goods directly to consumers, along with performing a wide range of services. Additionally, the exemplary methods demonstrate a mechanism for allowing system users (e.g., providers) to offer personalized services to other system users (e.g., consumers) that may be related to sales from a seller, even though the provider is not affiliated with the seller themselves.

To begin, each user (e.g., consumer and provider) can create a user account via the platform provider server to establish an account and be provided access to the system functionality. In one embodiment, the account information for each created user account can be maintained by the database 136, and can include, for example, personal information such as name, physical address, financial information (e.g., bank or credit card information), username, password, and email address, for example. In various embodiments, where digital currency is utilized, the registration process can also include assigning each registered user account an individual vault/wallet wherein financial information can be stored and available to the user via their selected interface device.

Once registered with the system, users can apply to provide personalized services through the system. To this end, the platform provider can use any number of internal or third-party systems to authenticate the potential services provider such as performing a background check, performing identity verification, and/or auditing the provided financial information before granting the applicant with access to the service provider options in the system.

Once a user has successfully registered as a provider, the system can provide the user with any number of different tools for allowing the provider to apply for available jobs (e.g., system generated or consumer custom) and to communicate with consumers upon being hired. Of course, many other steps may be included within the registration process. In either instance, upon completing the registration process, each user can be granted access to the system in order to purchase goods or provide personalized services in the manner described below.

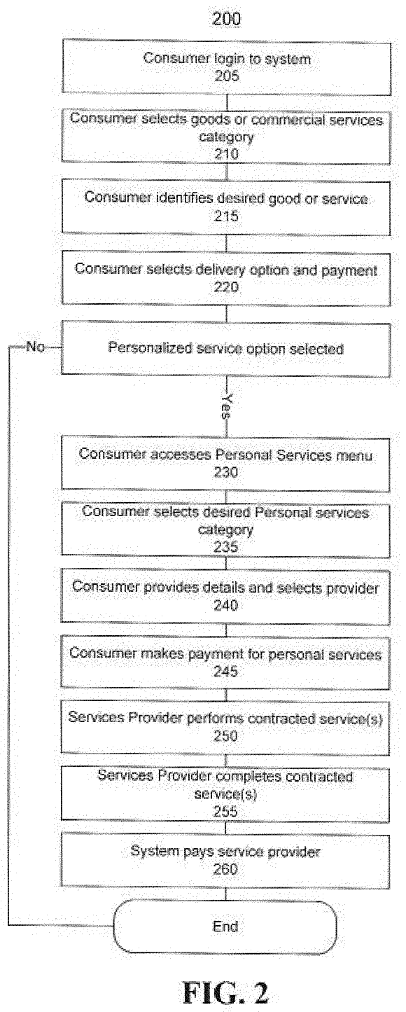

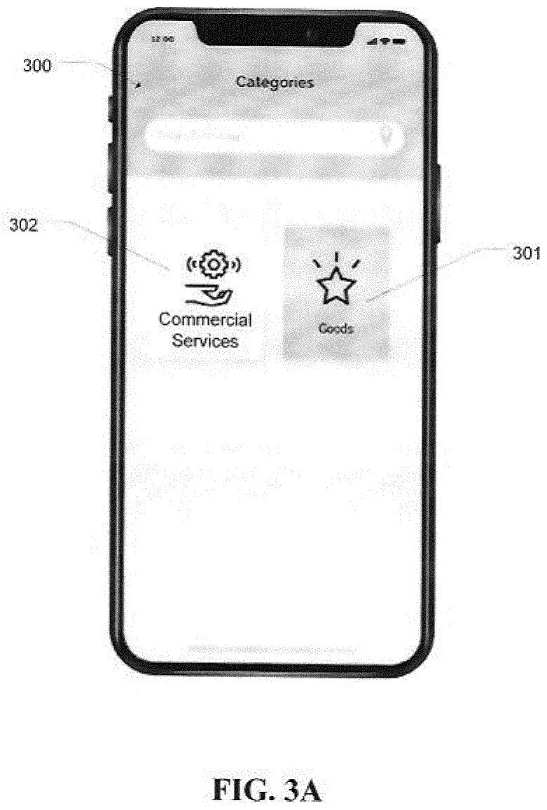

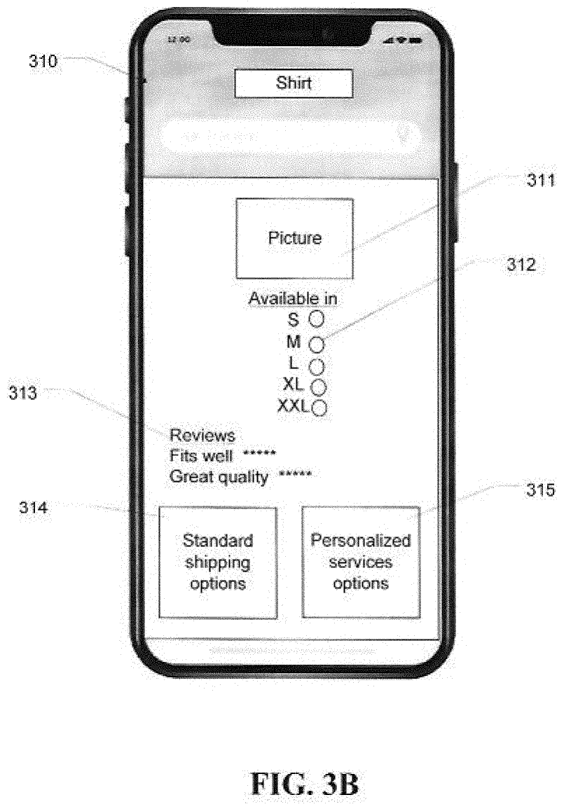

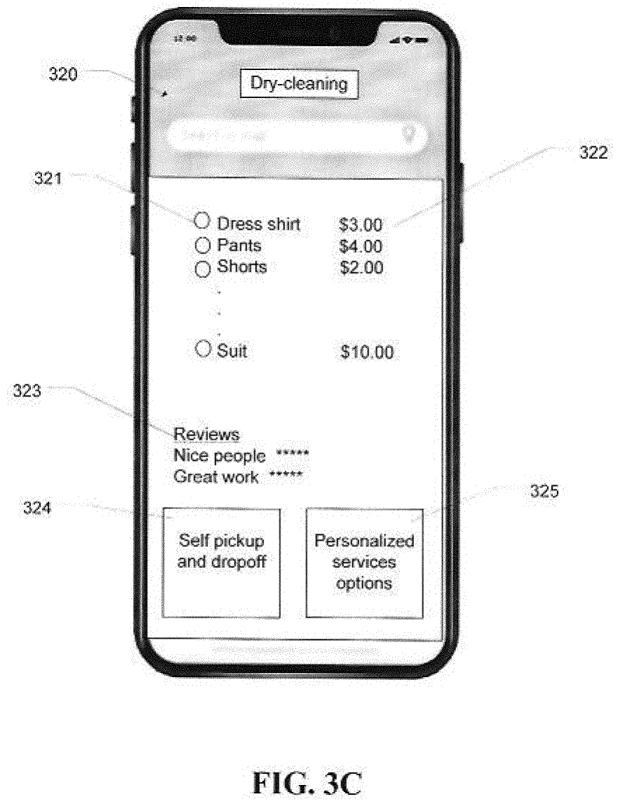

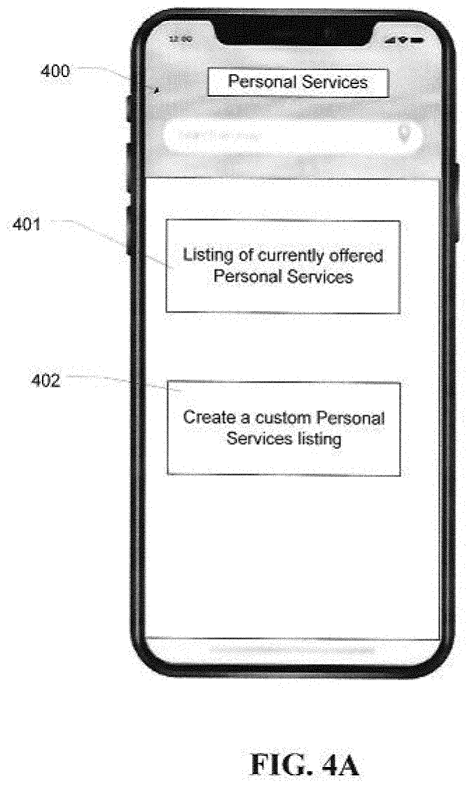

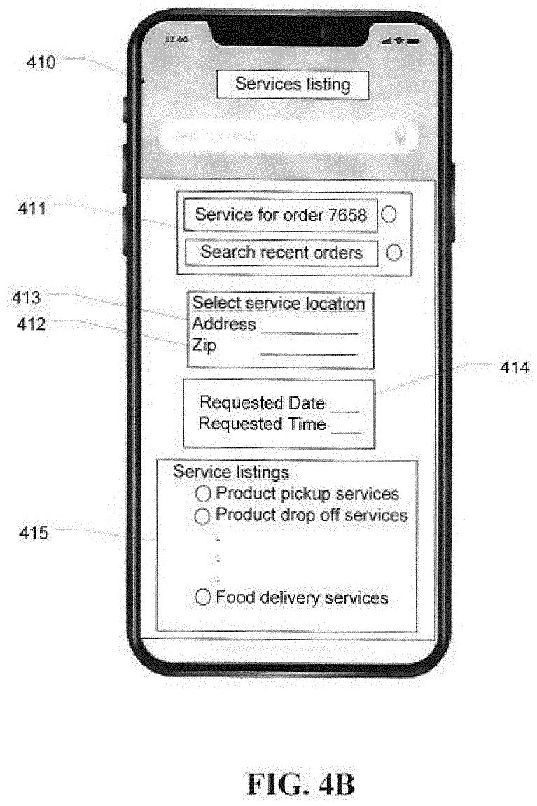

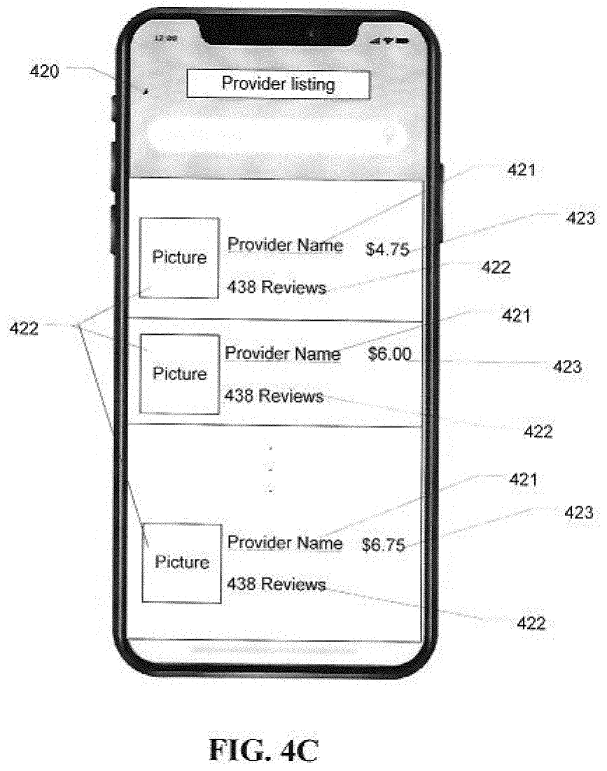

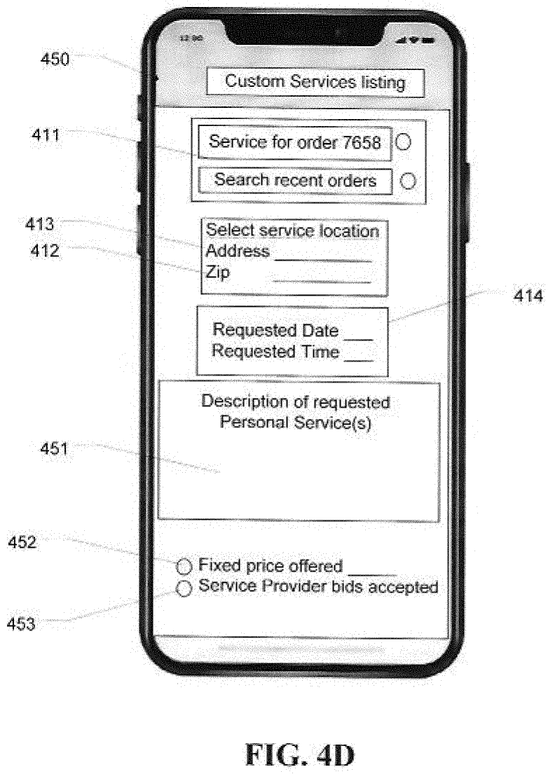

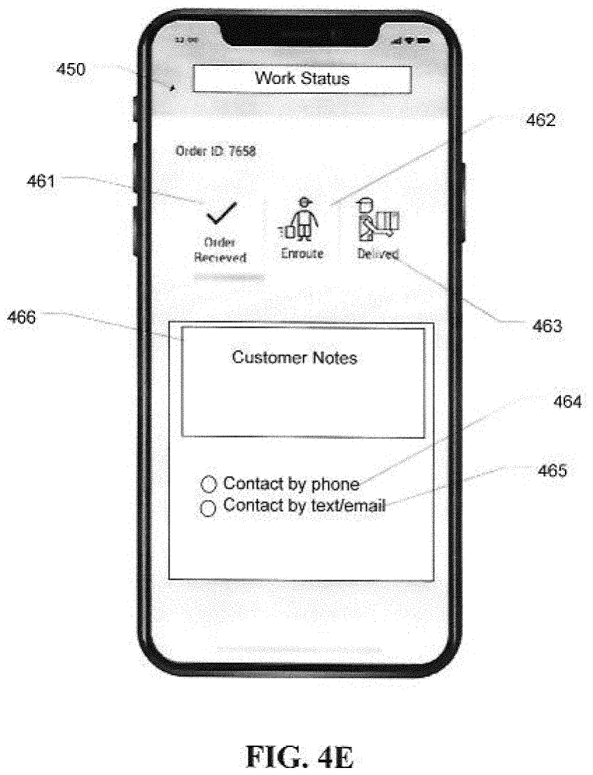

One simplified exemplary method 200 of purchasing goods from a seller and receiving personalized services from a provider using the system 100 will now be described with respect to FIG. 2. Moreover, several exemplary presentation screens that can be generated by the platform provider 130 and delivered to the consumer interface device 101 via the mobile App 15 or through the system website are presented with respect to FIGS. 3A-4E.

Although described below with respect to particular steps and screens, this is for illustrative purposes only, as the methodology described herein can be performed in a different order than shown, and the presentation screens can include any number of additional information and features.

As shown at FIG. 2, the method 200 can begin at step 205 where a consumer can log into the system and can be provided with options for browsing through a listing of goods and commercial services offered by sellers of the system. FIG. 3A illustrates one simplified and exemplary presentation screen 300 providing the consumer with options for browsing goods 301 from sellers and browsing through available commercial services 302 offered by sellers. The screen 300 may be generated by the platform provider 130 for display on the consumer interface device 101.

Returning to the method, at step 210 the user can select one of the offered tabs 301 or 302 at which time they will be taken to a different presentation screen where they can research, sort and browse through listings of goods and services offered by sellers through the system. The actual layout, searching mechanisms and offerings can be provided in virtually any manner, in accordance with known routines.

At step 215, the user can select a particular good or service from the available options provided by sellers. Upon selecting a particular good or service from the list, the system can generate a goods or service presentation screen to provide relevant detailed information about the selected good or service.

One simplified exemplary embodiment of a goods presentation screen 310, is shown at FIG. 3B. In the present example, the user has selected the goods icon 301 at step 210 and has searched through the listing screens of step 215 and has selected a shirt they are interested in purchasing. In one embodiment, goods presentation screen 310 can provide relevant information about the shirt, such as a picture 311, available sizes 312, product reviews 313, and options for receiving the item upon checkout, among others, for example. In the illustrated embodiment, two such options can include standard shipping 314, wherein the item can be shipped to the consumer using a commercial delivery service such as Fedex® or UPS®, for example. Additionally, the consumer can select delivery using the Personalized Services 315 of a provider, wherein the user can employ a services provider as described below.

As a second example, if the user wishes to purchase a commercial service such as dry-cleaning, for example, the user can select the Commercial Services icon 302 at step 210, and search through the listing screens at step 215 until they find a seller offering dry-cleaning services they would like to use.

One simplified example of a Commercial Services Presentation Screen 320 is shown at FIG. 3C and includes services information such as type of dry-cleaning services offered by the seller 321, pricing for each service 322, customer reviews 323, and delivery/pickup options. In the illustrated example, two such options can include self-delivery/pickup 324 or using the Personalized Services 325 of a provider, wherein the user can employ a services provider to pick up and/or deliver the clothing to the drycleaners.

At step 220, the consumer can select either traditional delivery option or personalized service option and can then conclude the transaction with the seller by providing payment at step 225. If a traditional delivery option (e.g., 314 or 214, for example) was selected, the cost for shipping can be included in the payment and the method can end upon the seller completing the contracted purchase.

However, if the consumer selects a personalized service option (e.g., 315 or 325, for example), then upon successful payment to seller, the user can be directed to the personal services menu at step 230. The personal services menu can be generated by the system 100 and can provide any number of different categories of personal services offerings for allowing the consumer to hire other users (e.g., providers) to perform various jobs/tasks for the consumer.

One embodiment of a Personalized Services presentation screen 400 is provided at FIG. 4A and can include categories such as a system-generated listing of services 401 and/or the ability for the consumer to create a Custom Service Request Listing 402. At step 235, the consumer can select one of these categories in order to receive personalized services.

For example, if the consumer selects tab 401 at step 235, the method can proceed to step 240 where the system can generate presentation screen 410 shown at FIG. 4B. As shown, at screen 410 the user can select a particular order number 411 (such as the order number for the shirt purchases above at FIG. 3B, for example) or can enter a specific geographic area 412, along with the address 413 where the service is to be performed. Also, the consumer can select a day and time at 414 when the service is to be completed, and the specific type of service 415 from the list such as product pickup and drop off services, vehicle pickup and drop off services, food delivery services, and others, for example.

Upon entering the requisite information, the system can next generate presentation screen 420 showing a listing of available providers. One exemplary provider presentation screen 420 is shown at FIG. 4C, and can include, for example, a list of service providers that are ready to perform the requested service at the requested location and at the requested day and time. The listing can include service provider names 421, photograph(s) 422, pricing 423 and reviews 424, for example.

Upon researching the providers from the list, the user can select any of the providers by clicking button 425. For example, the user can select pickup services 415 form the screen to have the shirt purchased at FIG. 3B picked up from the seller's retail location and delivered to the consumers home on a particular day or time. Although not specifically illustrated, the consumer may be provided with any number of other options for providing additional details to the selected provider. This may be in the form of a chat window, email, text message or phone call, for example.

Conversely, if the consumer selects the Custom Service Request Listing tab 402 at step 235, the method can proceed to step 240 where the system can generate presentation screen 450 shown at FIG. 4D. As shown at screen 450, the system can provide the consumer detail inputs 411-414 as described above and can also provide a detailed input section 451 where the consumer can list any number of specific services or tasks they wish to have performed, but that are not offered by the general listing.

For example, the consumer may list a custom job opening at section 451 requesting a services provider to pick up the shirt purchased at FIG. 3B from the seller location and deliver it to the dry-cleaner for the service purchased at FIG. 3C on the scheduled day and time. Upon completion of the dry-cleaning work the following day, the same (or a different) service provider can then pick up the dry-cleaned shirt and deliver it to the consumer. Of course, this is but one simplified exemplary example, the tasks requested by a consumer using the input section can be endless.

Although illustrated as a text box, this section can include any number of different user selectable options such as structured sentences (e.g., dropdown boxes referring to order number, items, actions, seller locations and services, for example). The screen can also allow the consumer to set a fixed price 452, or to receive bids 453 from service providers willing to perform the identified task(s).

In operation, the system 100 will review the requested services for compliance with any system conduct and guidelines and can then post the listings for each registered service provider to view. The listings can be in any suitable format, and providers may be chosen based on certain criteria such as preferred providers, best ratings, first to accept or lowest bid, as selected by the consumer and/or the platform provider.

In either instance, upon finding a service provider and agreeing to price, the method can proceed to step 245 where payment of the agreed amount can be made from the consumer to the system platform. In the preferred embodiment, funds can be held in trust by the platform for the benefit of the services provider until the services are actually performed. To this end, any service fees or other such charges may be deducted from the payment in accordance with the provider services agreement signed by the provider at a time of registration.

Next, the method can proceed to step 250 where the services provider can perform the selected service(s). During this time, the consumer can be provided with any number of status screens such as the Work Status Presentation screen 460 shown at FIG. 4E, for example. As shown, the work status screen can include a current status such as order received 461, Enroute 462, Completed 463, along with contact options such as voice 464 or text 465, along with a notes section 466, for example. Likewise, the consumer can be provided with real time map-based tracking using any number of third-party plugins and software.

Finally, at step 255 the service provider completes the contracted service(s), and upon acceptance and approval by the consumer, the system releases payment to the services provider at step 260.

Although described above with regard to a particular exemplary purchase and service performance, this is for illustrative purposes only to demonstrate the functionality of the inventive system. As such, any number of different products or commercial services can be purchased using the system, and any number of personalized services can be offered and performed by providers using the system functionality in any number of different markets.

Accordingly, the above-described system and method provide a novel and innovative means for providing and receiving goods and services that are not rendered obvious by any known art.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, aspects of the present invention may be embodied as a system, method or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
establishing communication between a plurality of user interface devices, at least one seller interface device, and a platform provider system over a network;
purchasing, via one of the plurality of user interface devices, an item from the at least one seller interface device using the platform provider system;
purchasing, via the one user interface device, a personalized service from another of the plurality of user interface devices using the platform provider system; and
receiving the purchased personalized service, wherein the personalized service imparts a physical transformation or conveyance of the purchased item.

2. The method of claim 1, wherein an operator of each of the plurality of user interface devices are not affiliated with an operator of the at least one seller interface device.

3. The method of claim 1, further comprising:
providing, via the platform provider system, a personalized services menu containing a plurality of personalized service categories.

4. The method of claim 3, wherein one of the personalized service categories includes a list of personalized service offerings by multiple of the plurality of interface devices.

5. The method of claim 4, wherein the list includes a service offering description and price.

6. The method of claim 3, wherein one of the personalized service categories includes a custom listing.

7. The method of claim 6, wherein the custom listing includes options for allowing the one user interface device to create a listing for a desired personalized service.

8. The method of claim 7, further comprising:
providing, via the platform provider, options for allowing each of the user interface devices to bid on the created listing.

9. The method of claim 8, further comprising:
providing, via the platform provider, options for allowing the one user interface device to select a winning bid.

10. The method of claim 9, further comprising:
providing, via the platform provider, communication options for allowing the one user interface to communicate directly with the user interface device of the winning bid.

11. A computer program product, tangibly embodied in a non-transitory computer readable medium, for providing and receiving goods and services, the computer program product including instructions being operable to cause a data processing apparatus to:
establishing communication with a first user interface device;
establish communication with a second user interface device;
establish communication with at least one seller interface device;
execute, via the first user interface device, a purchase of an item from the at least one seller interface device;
execute, via the first user interface device, a personalized service from the second user interface device, wherein the personalized service imparts a physical transformation or conveyance of the purchased item.
